(19) United States
(12) Patent Application Publication
(10) Pub. No.: US 2011/0296960 A1
(43) Pub. Date: Dec. 8, 2011

(54) Reversible ratchet wrench background of the invention

(76) Inventor: Ju Chen Chen, Naporville, IL (US)

(21) Appl. No.: 12/802,484

(22) Filed: Jun. 7, 2010

(51) Int. Cl. B25B 13/46

(52) U.S. Cl. 81/63

(57) ABSTRACT

A reversible ratchet wrench includes a head and a handle, and a bore and a compartment formed in the head, a driving member includes a shank engaged in the bore of the head and a gear engaged in the compartment of the head, a pawl is pivotally mounted in the head and includes two engaging teeth for controlling the driving direction of the gear of the driving member relative to the head, the pawl includes two side seats and a middle seat, and a spring-biased projection is engageable with either of the side seats of the pawl for controlling the driving direction of the gear relative to the head, and is engageable with the middle seat of the pawl for disengaging the engaging teeth from the gear and for allowing the gear to be freely rotated relative to the head.

### BACKGROUND OF THE INVENTION

1. Field of the Invention

The present invention relates to a reversible ratchet wrench, and more particularly to a reversible ratchet wrench including a control mechanism for allowing a driving shank or member to be freely rotated relative to the driving handle and to be quickly engaged into or disengaged from the work piece or the like.

2. Description of the Prior Art

Typical reversible ratchet wrenches comprise a wrench body including a unitary head and a driving handle, a driver including a driving lug attached or mounted or secured to the head, and a releasable detent mechanism also attached or mounted or secured to the head and engaged with the driver for controlling the driving direction of the driving lug of the driver relative to the work piece or the like.

For example, U.S. Pat. No. 4,512,218 to Chow, U.S. Pat. No. 4,532,832 to Christensen, U.S. Pat. No. 4,561,329 to Lack, U.S. Pat. No. 4,592,255 to Mayer, U.S. Pat. No. 4,631,988 to Colvin, U.S. Pat. No. 4,762,033 to Chow, U.S. Pat. No. 4,862,775 to Chow, and U.S. Pat. No. 5,178,047 to Arnold et al. disclose several of the typical reversible ratchet wrenches each also comprising a wrench body including a unitary head and a driving handle, a driving stud attached or mounted or secured to the head, and a releasable detent mechanism also attached or mounted or secured to the head and engaged with the driving stud for controlling the driving direction of the driving stud relative to the work piece or the like.

Normally, the releasable detent mechanism includes a pawl pivotally or rotatably attached or mounted or secured to the head, and a pawl-shifting pin attached or mounted to a release member and engageable with the pawl for controlling or actuating the pawl to engage with the ratchet teeth of a driver.

However, the pawl-shifting pin and the release member may only be used to control or actuate the pawl to engage with the ratchet teeth of the driver in either the active direction or the reverse direction; i.e., the pawl may not be disengaged from the ratchet teeth of the driver such that the driver may not be freely rotated relative to the driving handle or the wrench body and may not be quickly engaged into or disengaged from the work piece or the like by the user.

The present invention has arisen to mitigate and/or obviate the afore-described disadvantages of the conventional reversible ratchet wrenches.

### SUMMARY OF THE INVENTION

The primary objective of the present invention is to provide a reversible ratchet wrench including a control mechanism for allowing a driving shank or member to be freely rotated relative to the driving handle and to be quickly engaged into or disengaged from the work piece or the like.

In accordance with one aspect of the invention, there is provided a reversible ratchet wrench comprising a wrench body including a head and a handle, and including a bore formed in the head, and including a compartment formed in the head and located above the bore of the head and having a dimension greater than that of the bore of the head for forming an inner peripheral shoulder in the head, a driving member including a driver shank rotatably engaged in the bore of the head, and including a gear provided on the driver shank and engaged in the compartment of the head and having a dimension greater than that of the driver shank for engaging with the inner peripheral shoulder of the head and for anchoring the gear and the driver shank in the head, a pawl pivotally mounted in the compartment of the head and including a first engaging tooth and a second engaging tooth for selectively engaging with the gear and for controlling a driving direction of the gear of the driving member relative to the head, the pawl including two side seats and a middle seat provided on the pawl and located opposite to the first and the second engaging teeth, and the middle seat being located between the two side seats, and a spring-biased projection engaged in the head and engageable with either of the side seats of the pawl for controlling a driving direction of the gear of the driving member relative to the head, and the spring-biased projection being engageable with the middle seat of the pawl for disengaging the first and the second engaging teeth from the gear and for allowing the gear of the driving member to be freely and quickly rotated relative to the head.

The wrench body includes a cover attached to the head and having an orifice formed in the cover for rotatably receiving and engaging with the driver shank, the cover includes an aperture formed therein, and the pawl includes a shaft rotatably received and engaged in the aperture of the cover for anchoring and retaining the pawl in the head.

The wrench body includes a space formed in the head and located above the compartment of the head and having a dimension greater than that of the compartment of the head for forming an inner peripheral shoulder in the head and for engaging with the cover.

The pawl includes a non-circular engaging element extended from the pawl, and a switch member includes a non-circular engaging hole formed therein for engaging with the non-circular engaging element of the pawl and for attaching the switch member to the pawl and for allowing the pawl to be suitably pivoted relative to the head with the switch member.

The pawl includes at least one fastener engaged with the switch member and the pawl for solidly securing the switch member to the pawl. The driving member includes a non-circular engaging hole formed therein for selectively engaging with a driving tool and for allowing the driver shank to be rotated relative to the head by the driving tool.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating the operation of a reversible ratchet wrench in accordance with the present invention;

FIG. 2 is an exploded view of the reversible ratchet wrench;

FIG. 3 is a top plan schematic view of the reversible ratchet wrench, in which a portion of the reversible ratchet wrench has been cut off for showing the inner structure of the reversible ratchet wrench;

FIG. 4 is a top plan schematic view similar to FIG. 3, illustrating the other arrangement of the reversible ratchet wrench; and

FIG. 5 is a partial exploded view illustrating the further arrangement of the reversible ratchet wrench.

### DETAILED DESCRIPTION OF THE PREFERRED EMBODIMENT

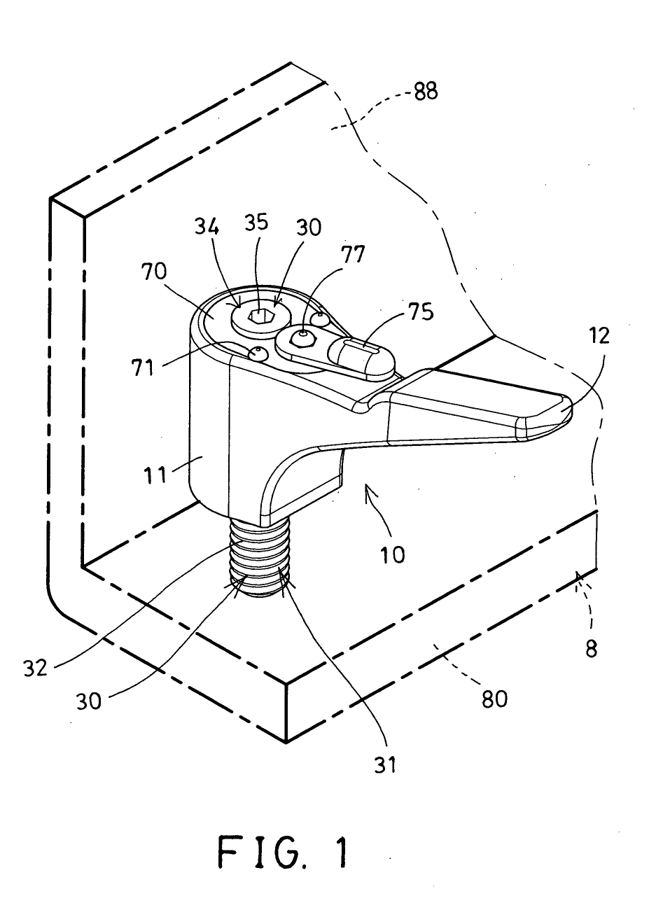

Referring to the drawings, and initially to FIGS. 1-3, a reversible ratchet wrench in accordance with the present invention comprises a wrench body 10 including a unitary head 11 and a driving handle 12, and including a bore 13 formed in the head 11, and including a compartment 14 also formed in the head 11 and located above the bore 13 of the head 11, or formed in the upper portion of the head 11 and having an inner area or diameter or space or dimension greater than that of the bore 13 of the head 11 for forming an inner peripheral shoulder 15 in the head 11 and located between the bore 13 and the compartment 14 of the head 11, and further including a depression or space 16 also formed in the head 11 and located above the compartment 14 of the head 11 and having an inner area or diameter or space or dimension greater than that of the compartment 14 of the head 11 for forming another inner peripheral shoulder 17 in the head 11 and located between the space 16 and the compartment 14 of the head 11, and further including a cavity 18 formed in the head 11 and communicative with the compartment 14 of the head 11.

A driving member 30 includes a driver shank 31 pivotally or rotatably engaged into the bore 13 of the head 11, and includes an outer thread 32 formed in the outer peripheral portion of the driver shank 31 for engaging into or with a panel 80 of a work piece 8 or the like (FIG. 1), and includes a gear 33 formed or provided on the upper portion 34 of the driver shank 31 and received or engaged in the compartment 14 of the head 11, and having an outer diameter or dimension greater than that of the driver shank 31 for stably engaging with the inner peripheral shoulder 15 of the head 11 and for stably anchoring or positioning or retaining the gear 33 and the driver shank 31 of the driving member 30 in the head 11 and arranged for allowing the gear 33 and the driver shank 31 of the driving member 30 to be suitably pivoted or rotated relative to the head 11. It is preferable, but not necessarily that the driving member 30 further includes a non-circular engaging hole 35 formed or provided in the upper portion 34 of the driver shank 31 for selectively engaging with the other driving tools (not shown) and for allowing the driver shank 31 of the driving member 30 to be suitably driven or rotated relative to the head 11 by the driving tools.

A releasable detent mechanism 5 includes a pawl 50 pivotally or rotatably attached or mounted or secured in the compartment 14 of the head 11, and the pawl 50 includes two engaging teeth 51, 52 for selectively engaging with the gear 33 and for controlling the driving direction of the gear 33 of the driving member 30 relative to the head 11, and the pawl 50 further includes two side seats 53, 54 and a middle seat 55 formed or provided on the pawl 50 and located distal to or opposite to the engaging teeth 51, 52, and includes a circular shaft 56 and a non-circular engaging element 57 extended upwardly from the pawl 50, and includes a screw hole or engaging hole 58 formed in the engaging element 57 and/or the shaft 56 of the pawl 50, in which the middle seat 55 is located between the two side seats 53, 54. A spring-biased projection 59 is engaged in the cavity 18 of the head 11 and engageable with either of the seats 53, 54, 55 of the pawl 50 for controlling the driving direction of the gear 33 of the driving member 30 relative to the head 11 and the work piece 8 or the like.

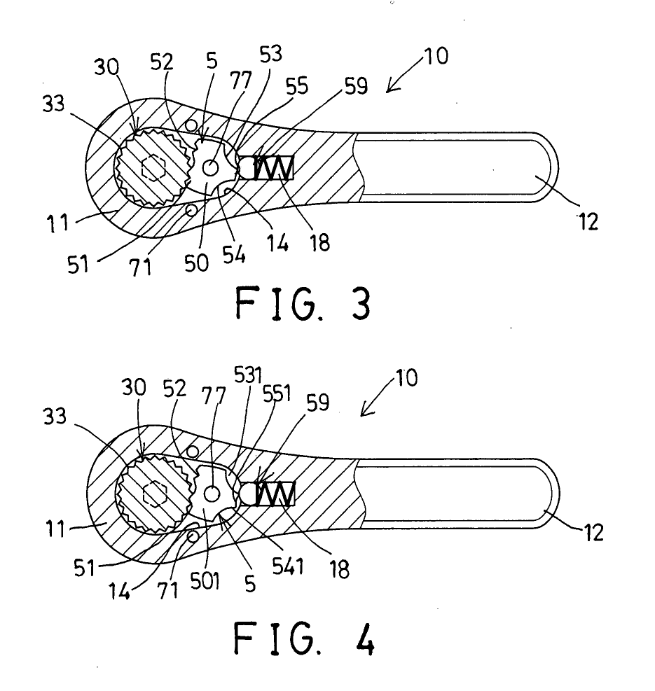

In operation, as shown in FIG. 3, the spring-biased projection 59 is engageable with either of the seats 53, 54 of the pawl 50 for controlling the driving direction, such as in either the active direction or the reverse direction of the gear 33 of the driving member 30 relative to the head 11. In addition, the spring-biased projection 59 is also engageable with the middle seat 55 of the pawl 50 for disengaging the engaging teeth 51, 52 of the pawl 50 from the gear 33 and thus for allowing the gear 33 of the driving member 30 to be freely and quickly rotated relative to the head 11 and the driving handle 12 of the wrench body 10 in a greater speed by the user, for example.

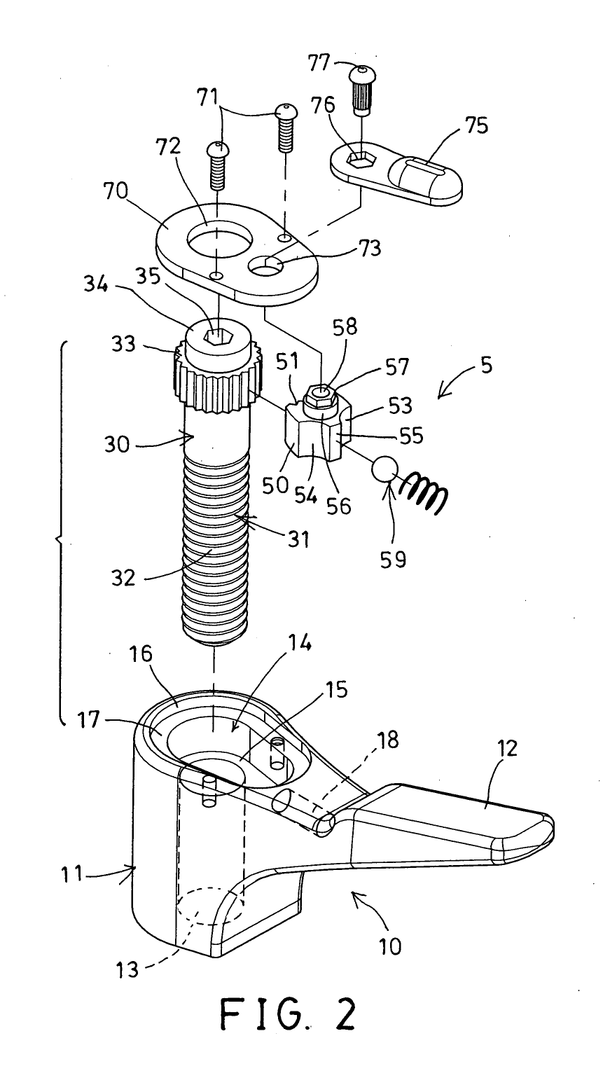

Particularly, as shown in FIG. 1, when the work piece 8 includes two panels 80, 88 perpendicular to each other, and when the wrench body 10 is disposed or located between the panels 80, 88, or located close to the panels 80, 88, it will be difficult to rotate or drive the wrench body 10 relative to the panels 80, 88 of the work piece 8, and it will be important that the driving member 30 may be freely and quickly rotated relative to the head 11 and the driving handle 12 of the wrench body 10 in a greater speed. It is to be noted that the seats 53, 54, 55 of the pawl 50 may include a planar structure (FIGS. 2, 3) or the pawl 501 may include a concave or curved structure for the seats 531, 541, 551 (FIG. 4) and for stably engaging with the spring-biased projection 59 and for stably anchoring or positioning the spring-biased projection 59 and the pawl 50.

A cap or cover 70 is attached or mounted or secured onto the head 11 and engaged into the space 16 of the head 11, and secured to the head 11 with one or more latches or couplers or fasteners 71 and engaged with the gear 33 of the driving member 30 for stably and rotatably anchoring or positioning or retaining the gear 33 and the driver shank 31 of the driving member 30 in the head 11, and includes an orifice 72 formed therein for rotatably receiving or engaging with the upper portion 34 of the driver shank 31, and includes an aperture 73 formed therein for rotatably receiving or engaging with the circular shaft 56 of the pawl 50 and thus for stably and rotatably anchoring or positioning or retaining the pawl 50 in the head 11. A hand grip or knob or switch member 75 may further be provided and includes a non-circular engaging hole 76 formed therein for engaging with the non-circular engaging element 57 of the pawl 50 and for attaching or mounting or securing the switch member 75 to the pawl 50 and thus for allowing the pawl 50 to be suitably pivoted or rotated relative to the head 11 by or with the switch member 75 which may further be solidly secured to the pawl 50 with one or more latches or fasteners 77.

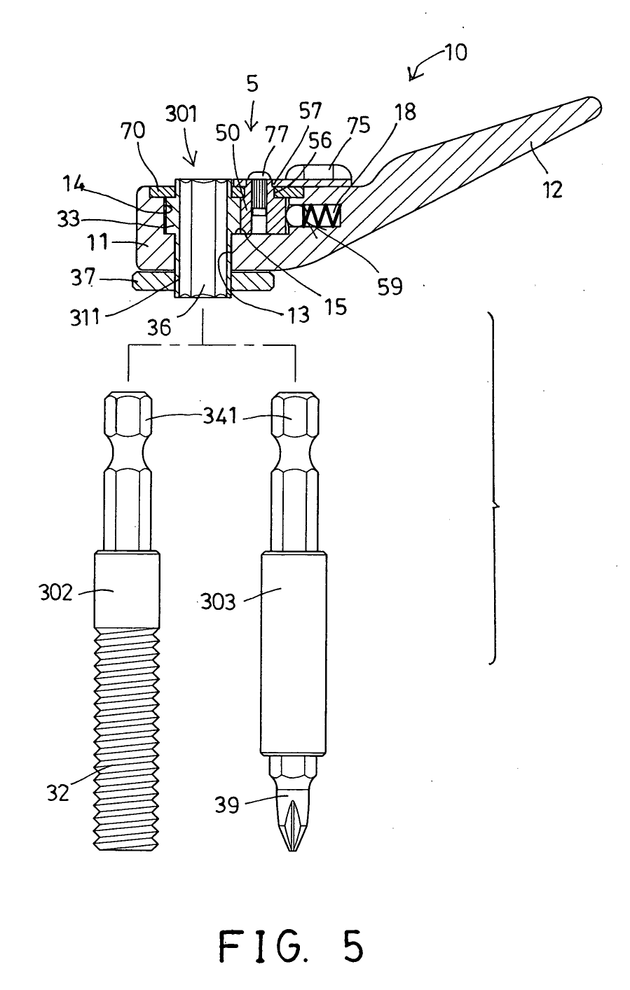

Alternatively, as shown in FIG. 5, the driving member 301 may include a non-circular engaging chamber 36 formed therein, such as formed in the driver shank 311 of the driving member 301 for engaging with the non-circular stem 341 of the other driving tool elements 302, 303, in which the driving tool element 302 may also include an outer thread 32 formed in the outer peripheral portion of the driving tool element 302 for engaging into or with the panel 80 of a work piece 8 or the like, or the other driving tool element 303 may include a driver bit 39 for engaging with the screws, bolts or other driven or fastener members (not shown). A plate or control ferrule 37 may further be provided and attached or mounted or secured to the driver shank 311 of the driving member 301 for quickly driving or rotating the driving member 30 relative to the head 11 and the driving handle 12 of the wrench body 10 in a greater speed.

Accordingly, the reversible ratchet wrench in accordance with the present invention includes a control mechanism for allowing a driving shank or member to be freely rotated relative to the driving handle and to be quickly engaged into or disengaged from the work piece or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A reversible ratchet wrench comprising:
a wrench body including a head and a handle, and including a bore formed in said head, and including a compartment formed in said head and located above said bore of said head and having a dimension greater than that of said bore of said head for forming an inner peripheral shoulder in said head,
a driving member including a driver shank rotatably engaged in said bore of said head, and including a gear provided on said driver shank and engaged in said compartment of said head and having a dimension greater than that of said driver shank for engaging with said inner peripheral shoulder of said head and for anchoring said gear and said driver shank in said head,
a pawl pivotally mounted in said compartment of said head and including a first engaging tooth and a second engaging tooth for selectively engaging with said gear and for controlling a driving direction of said gear of said driving member relative to said head, said pawl including two side seats and a middle seat provided on said pawl and located opposite to said first and said second engaging teeth, and said middle seat being located between the two side seats, and
a spring-biased projection engaged in said head and engageable with either of said side seats of said pawl for controlling a driving direction of said gear of said driving member relative to said head, and said spring-biased projection being engageable with said middle seat of said pawl for disengaging said first and said second engaging teeth from said gear and for allowing said gear of said driving member to be freely and quickly rotated relative to said head.

2. The reversible ratchet wrench as claimed in claim 1, wherein said wrench body includes a cover attached to said head and having an orifice formed in said cover for rotatably receiving and engaging with said driver shank, said cover includes an aperture formed therein, and said pawl includes a shaft rotatably received and engaged in said aperture of said cover for anchoring and retaining said pawl in said head.

3. The reversible ratchet wrench as claimed in claim 2, wherein said wrench body includes a space formed in said head and located above said compartment of said head and having a dimension greater than that of said compartment, of said head for forming an inner peripheral shoulder in said head and for engaging with said cover.

4. The reversible ratchet wrench as claimed in claim 1, wherein said pawl includes a non-circular engaging element extended from said pawl, and a switch member includes a non-circular engaging hole formed therein for engaging with said non-circular engaging element of said pawl and for attaching said switch member to said pawl and for allowing said pawl to be suitably pivoted relative to said head with said switch member.

5. The reversible ratchet wrench as claimed in claim 4, wherein said wrench body includes at least one fastener engaged with said switch member and said pawl for securing said switch member to said pawl.

6. The reversible ratchet wrench as claimed in claim 1, wherein said driving member includes an engaging hole formed therein.
